(19) United States
(12) Patent Application Publication
(10) Pub. No.: US 2024/0361028 A1
(43) Pub. Date: Oct. 31, 2024

(54) SYSTEM AND METHOD FOR BUILDING ENERGY USE IMPROVEMENT

(71) Applicant: Microsoft Technology Licensing, LLC, Redmond, WA (US)

(72) Inventors: Miriam Berhane RUSSOM, San Jose, CA (US); Nan MA, Cambridge, MA (US); Stephanie Ann DRENCHEN, Seattle, WA (US); Tyler James ANGELL, Issaquah, WA (US); Lei SONG, Shanghai (CN); Jiang BIAN, Beijing (CN)

(21) Appl. No.: 18/309,728

(22) Filed: Apr. 28, 2023

(51) Int. Cl. F24F 11/46; F24F 11/64

(52) U.S. Cl. CPC F24F 11/46; F24F 11/64; F24F 2110/12

(57) ABSTRACT

A method for modifying energy consumption by a building includes receiving sensor data generated by a sensor, where the sensor data is indicative of at least one of a mixed air temperature, an outside air temperature, or air tonnage. The method further includes providing the sensor data as input into a computer-implemented machine learning model that is trained by way of reinforcement learning. The method also includes computing a setpoint modification through use of the machine learning model, where energy consumption is reduced based upon an HVAC system for the building implementing the setpoint modification.

### BACKGROUND

Buildings are one of the largest consumers of electricity and are responsible for a considerable portion of harmful CO₂ emissions into the environment. In the United States alone, buildings account for approximately 76% of all electricity consumption and greater than 33% of emissions. Making buildings more efficient is therefore a powerful tool to address climate change and reduce overall emissions. Heating, ventilation, and air conditioning (HVAC) in buildings is a significant portion of overall building energy demand. HVAC systems are used to control the indoor environment of buildings to maintain safe and comfortable conditions for building occupants despite variable external environmental conditions.

Conventional HVAC systems are controlled using system setpoints. Typically, these setpoints are only changed seasonally, at periodic intervals throughout the year, or reactively based on incidents. Configuration and calibration of conventional HVAC systems is done manually at the equipment system level and is unable to account for variables such as building occupancy, grid load, energy price, weather, and emissions. The inability of conventional HVAC systems to account for these variables results in surplus energy consumption and increases operational cost for the building.

### SUMMARY

The following is a brief summary of subject matter that is described in greater detail herein. This summary is not intended to be limiting as to the scope of the claims.

Described herein are various technologies pertaining to an energy efficiency optimization application configured to generate and apply improved control inputs for a building heating, ventilation, and air conditioning (HVAC) system. HVAC systems are used to manage the indoor environment of buildings, managing environmental conditions such as temperature, humidity, pressure, and ventilation within the building. Typically, HVAC systems are controlled according to manually applied system setpoints. These setpoints are only changed periodically, for example, at the start of each climate season. The periodic and static nature of these changes to the setpoints results in numerous inefficiencies in conventional HVAC systems, such as heating the building during a warm winter day or cooling the building during a mild summer day. The technologies described herein relate to improving the efficiency of building HVAC control through use of an energy efficiency application configured to generate and apply setpoint controls to a building HVAC system in real-time or near real-time.

In a nonlimiting example, a computing system comprises a processor and memory having an energy efficiency application stored thereon. When the energy efficiency application is executed by the processor, the application receives a first energy consumption metric for an HVAC system of a building, wherein the HVAC system is configured to regulate the indoor environment of the building according to one or more setpoints. The first energy consumption metric is a real-time or near real-time indication of the energy consumed by the HVAC system during operation, which can be expressed in kilowatt hours (kWh).

The energy efficiency application is further configured to receive sensor data generated by various sensors in the building. Every building has a number of sensors disposed throughout that collect information relating to the environmental conditions of the building, both inside and outside. For instance, a building may have indoor sensors that monitor temperature, humidity, etc., within the building. The building may also have sensors that monitor building activity and occupancy. Outdoor sensors can gather temperature, humidity, and air quality information relating to the outside environment. The sensor data is collected by a building management system that connects systems in the building.

The HVAC system itself has sensors located at different points of the HVAC system. For example, the HVAC system has sensors that measure air temperature, static pressure, and air tonnage. Air temperature sensors measure the temperature of air at various points in the HVAC process. For example, temperature sensors may record an outside air temperature (OAT), which is the temperature of outside air as it enters the HVAC system, return air temperature, which is the temperature of air that reenters the HVAC system from inside the building's return registers, and a mixed air temperature (MAT), which is the temperature of the combination of conditioned air, outside air, and return air. Temperature sensors may also be used to determine the temperature of air discharged from the HVAC system into the building. Sensors may also measure the static pressure, which is the resistance to airflow within the air ducts of the HVAC system. For HVAC systems to function correctly, air needs to be pushed through the air ducts with greater intensity than the static pressure level within the ducts. An HVAC unit with either too high or too low static pressure will result in increased energy consumption and contribute to overall system inefficiency.

As mentioned previously, the sensor data is collected by the building management system. The building management system controls aspects of a building, including lighting, alarm systems, and HVAC. The energy efficiency application can acquire the sensor data from the building management system in regular intervals to monitor the environmental conditions of the building and its surroundings. When the energy efficiency application receives the sensor data, the application provides the sensor data as input into a computer-implemented machine learning model that is configured to determine a setpoint modification for the HVAC system. The machine learning model has learned parameters based on historical data of the HVAC system. The historical data is indicative of the historical operational behavior of the HVAC system over time, such as what setpoints were applied, when they were applied, how often the setpoints were modified, etc. The historical data may also comprise historical energy metrics that detail the energy consumption by the HVAC system over time. The historical energy consumption metrics form a baseline of how much energy the HVAC system consumes based on the historical setpoints. In certain embodiments, the historical data comprises data from a simulated HVAC system.

The setpoint modification output of the machine learning model is a recommended change to one or more HVAC setpoints that that will result in a decrease in energy consumption and increase in HVAC system efficiency compared to the first energy consumption metric received by the energy efficiency application. While increasing efficiency, the setpoint modification also maintains the safety and comfort of the building occupants. The energy efficiency application transmits the setpoint modification output to the building management system and causes the setpoint modification to be applied to the HVAC system.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a functional block diagram of a system for building energy use optimization.

FIG. 2 is a schematic that depicts an exemplary air handling unit of an HVAC system.

FIG. 3 is a flow diagram that illustrates an example methodology for training a machine learning model configured to determine a setpoint modification for an HVAC system;

FIG. 4 is a flow diagram that that illustrates an example methodology for training a machine learning model using a simulate HVAC system.

FIG. 5 is a schematic of a computing system.

### DETAILED DESCRIPTION

Various technologies pertaining to an energy efficiency application are now described with reference to the drawings, where like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component”, “system”, “module”, and “model” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Described herein are various technologies pertaining to an energy efficiency application configured to generate and apply improved setpoint control for a building HVAC system. A deficiency with conventional HVAC systems is that they are controlled using limited and manual setpoint modification, typically during periodic intervals, such as at the beginning of each climate season. The static nature of these setpoints creates operational inefficiencies in the HVAC system and leads to excessive energy consumption. For example, during the winter season, an HVAC temperature setpoint may be 72 degrees Fahrenheit. The HVAC system will continue to heat the building to 72 degrees even in an unseasonably warm 65 degree winter day in which a lower building setpoint would be comfortable for the occupants. In another example, static controls can result in excessive heating or cooling in a building even when the building is substantially unoccupied.

The technologies described herein overcome the deficiencies of conventional HVAC setpoint control by generating and applying improved setpoint controls in response to real-time sensor feedback from the HVAC system. In an exemplary embodiment, an energy efficiency application is configured to generate and apply improved setpoint controls to an HVAC system which results in a decrease in building energy consumption. The energy efficiency application utilizes real-time sensor data from the building to provide inputs into a machine learning model. The machine learning model then outputs setpoint controls which reduce energy consumption of the HVAC system. The energy efficiency application transmits the setpoint controls to a building management system and causes the setpoints to be applied to the building's HVAC system. These technologies are described in greater detail herein.

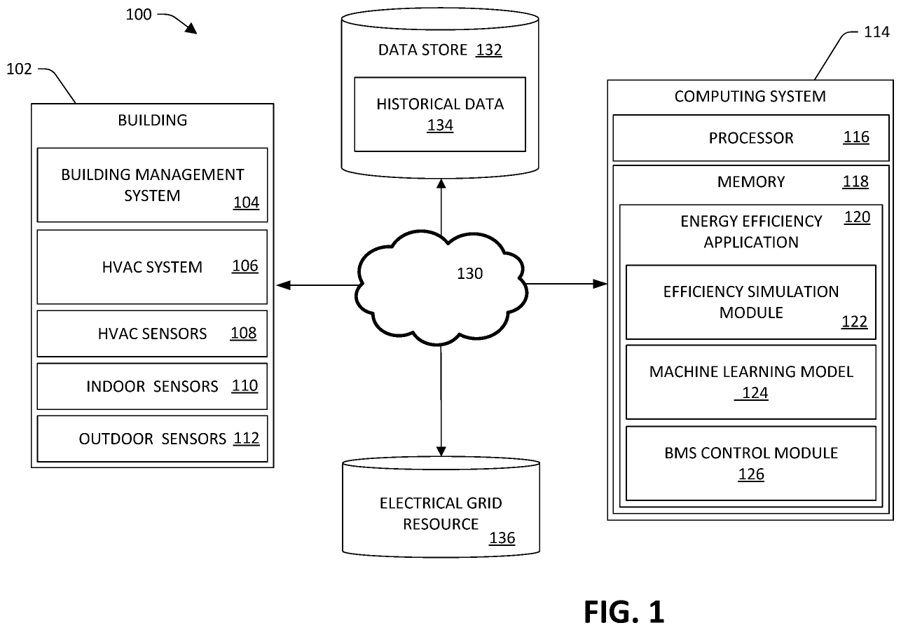

Referring now to FIG. 1, a functional block diagram of a system 100 is depicted. The system 100 comprises a building 102 that includes systems and sensors that are in data communication with a computing system 114 by way of network 130. Building 102 can be any structure such as an office building, school, hospital, or the like. While building 102 may be any size, for purposes of explaining the functionality of the exemplary system 100, it is contemplated that building 102 is a large commercial-scale building requiring a building-wide HVAC system capable of consistently managing the indoor environment for the entire building.

Building 102 comprises a building management system 104. The building management system 104 is a computer-implemented system configured to control and monitor certain aspects of building 102. For example, building management system 104 is configured to monitor and control lighting, power systems, fire systems, security systems, and HVAC for building 102. Building management system 104 is also configured to monitor the real-time or near real-time energy consumption of each system in building 102. The building management system 104 may be further in data communication with electrical grid resource 136 (e.g., via network 130) to determine overall electrical grid demand and utility pricing.

In certain embodiments, building management system 104 comprises a user interface configured to receive setpoint control inputs from an operator, such as a building manager. The building management system 104 user interface may be configured as a graphical user interface which can generate graphics and visualizations relating to operation of the systems managed by building management system 104. Building management system 104 may receive setpoint control inputs via network 130, for example, from computing system 114 or other external system configured to control the building management system 104 remotely.

Building 102 further comprises HVAC system 106 for regulating the indoor environment of the building 102 through heating, ventilation, and air conditioning. Depending on the needs and configuration of building 102, HVAC system 106 may be configured with various combinations of components to perform heating, ventilation, and air conditioning on the building 102. For example, HVAC system 106 may comprise an air conditioning component, a compressor component, a condenser component, a thermal expansion valve, an air handling unit (AHU), a chiller component, a heat generator, and a duct system. The HVAC system 106 may further comprise filters to remove particulates from the air and blowers to move the air throughout various points in the system.

Various alternative arrangements of HVAC system 106 components are contemplated based on the location, surrounding climate, and use of building 102. The various components of HVAC system 106 work together to condition air in the building according to system setpoints administered by the building management system 104.

Building 102 further comprises sensors 108, 110, and 112 that generate sensor data about the building. Sensors 108, 110, and 112 are disposed throughout the building 102 and collect information relating to the environmental conditions surrounding the building, both inside and outside. The sensors 108, 110, and 112 transmit the sensor data to the building management system 104. The HVAC system 106 itself has HVAC sensors 108 located at various points of the HVAC system 106. HVAC sensors 108 measure air tonnage, air temperature, and static pressure. Air tonnage is the amount of heat that the HVAC system 106 can remove from the building in an hour. Air temperature is the temperature of air at various points in the HVAC process. For example, outside air temperature (OAT) is the temperature of outside air as it enters the HVAC system. Return air temperature is the temperature of air that reenters the HVAC system from inside the building's return registers. Mixed air temperature (MAT) is the temperature of the combination of conditioned air, outside air, and return air.

HVAC sensors 108 are further configured to determine the temperature of air discharged from the HVAC system into the building. The temperature of discharged air is one of the setpoints applied to HVAC system 106 to maintain indoor conditions of building 102. In an example, the BMS 104 can control the HVAC system 106 in order to maintain a certain setpoint discharge air temperature, or a range of acceptable discharge air temperatures. Acceptable discharge air temperatures will vary according to desired comfort levels and applicable safety protocols for the building 102. HVAC sensors 108 also measure the static pressure, which is the resistance to airflow within the air ducts of the HVAC system 106. Static pressure is another setpoint applied to the HVAC system 106. For HVAC systems to function correctly, air needs to be pushed through the air ducts with greater intensity than the static pressure level within the ducts. A system with either too high or too low static pressure will result in increased energy consumption and contribute to overall system inefficiency. Maintaining a consistent static pressure will result in increased energy efficiency of the HVAC system.

Indoor sensors 110 monitor temperature, humidity, etc., within the building. Indoor sensors 110 are also configured to monitor building activity and occupancy. One common inefficiency with conventional HVAC control is excessive heating and cooling when the building is not at full capacity. Understanding the activity within the building 102 is an important data point when determining HVAC control setpoints. For instance, if a building is not very full, the overall building energy demand is lower as fewer occupants use lighting, computers, copiers, elevators, etc. Fewer occupants may also mean that certain sections of a building may be conditioned differently based on the activity in each section. For example, if one floor is empty, it can be conditioned according to different parameters than an occupied floor, such as a lower temperature than would otherwise be within comfortable ranges for an occupied floor. Occupancy levels can also contribute to the indoor environment sensor readings. For example, a very crowded building will result in excess CO₂ exhaled by the occupants which may require additional ventilation to be performed by the HVAC system 106.

Outdoor sensors 112 gather temperature, humidity, and air quality information relating to the outside environment. The outdoor sensors 112 may detect environmental anomalies that can affect the efficiency and energy consumption of HVAC system 106. For example, outdoor air quality sensors may determine that external air is of poor air quality, for example, because of environmental conditions like severe weather or wildfires. In this example, more air may be recirculated through HVAC system 106 rather than brought into the system from outside.

The sensor data generated by sensors 108, 110, and 112 is collected by building management system 104 and may be stored, for example, at data store 132. Data store 132 receives data from HVAC system 106, sensors 108-112, and building management system 104, for example, over network 130. While depicted as a single entity, it is appreciated that data store 132 may be distributed in nature, comprising many different data storages. Data store 132 comprises historical data 134 which describes use of HVAC system 106 over time. More specifically, historical data 134 comprises data relating to the setpoints applied to HVAC system 106 and the corresponding energy consumption metrics resulting from the applied setpoints. As setpoints are applied and modified by energy efficiency optimization application 120, they may be logged at data store 132 as feedback data. The feedback data can then be used to further refine the machine learning model 124 and produce improved energy efficiency outcomes.

System 100 further comprises a computing system 114 for implementing the energy efficiency techniques disclosed herein. The computing system 114 comprises a processor 116 and a memory 118. Memory 118 has an energy efficiency application 120 installed thereon, such that when the application 120 is executed by processor 116, the application 120 performs energy efficiency activities. The energy efficiency application 120 is configured to perform energy efficiency operations with respect to HVAC system 106 through generation and application of setpoint controls administered via BMS 104. The energy efficiency application 120 comprises an energy efficiency simulation module 122, a machine learning model 124, and a building management system control module 126.

The energy efficiency simulation module 122 is configured to simulate certain aspects related to building 102. In an example, energy efficiency simulation module 122 generates or receives a digital replication of building 102. The digital replication or “digital twin” of building 102 can reproduce aspects of building 102, including associated technologies, systems, equipment, sensors, and actors (e.g., HVAC system 106, sensors 108, 110, 112). Once the digital twin of building 102 is generated or received, energy efficiency simulation module 122 can create an energy efficiency simulation to simulate how the systems of building 102 react to certain applied stimuli. In an example, energy efficiency simulation module 122 uses historical data 136 to train a simulated HVAC system that simulates operation of HVAC system 106. Training the simulated HVAC with historical data 136 improves the simulation and increases the correlation between simulated and actual performance of HVAC system 106. The energy efficiency simulation module 122 may simulate all or a portion of HVAC system 106. In an example, energy efficiency simulation module 122 may only simulate the air handling unit (AHU) of HVAC system 106 and observe operation of the simulated AHU.

Energy efficiency application 120 further comprises a machine learning model 124. Machine learning model 124 comprises one or more machine learning models that are used to generate optimized control inputs for HVAC system 106. In an example, machine learning model 124 is a reinforcement learning (RL) model (e.g., a model that is trained and adapts by way of reinforcement learning). RL is a type of machine learning that involves training a model through trial and error, where positive outcomes are rewarded and negative outcomes are punished. In the context of HVAC control, a positive outcome for an RL model is a setpoint modification that results in a decrease in energy consumption by the HVAC system while maintaining the safety and comfort of building occupants. A negative outcome is a setpoint modification that causes an uncomfortable or unsafe condition or an increase in energy consumption. In an example, the machine learning model 124 is an RL model that is trained using historical data (e.g., historical data 134). Historical data 134 describes the use of HVAC system 106 over time. More specifically, historical data 134 comprises data relating to the setpoints applied to HVAC system 106 and the corresponding energy consumption metrics resulting from the applied setpoints. From these observed historical energy consumption metrics, the machine learning model can learn specific adjustments that are likely to result in a reduction in energy consumption by the HVAC system.

Machine learning model 124 may be trained using actual or simulated historical data. Actual historical data is historical data that was observed (e.g., by BMS 104) in real-life operation of HVAC system 106, such as historical data 134. Simulated historical data is historical data that is generated as part of a simulation performed by efficiency simulation module 122. The machine learning model 124 may also be trained with the efficiency simulation module 122. The machine learning model 124 can be trained with an “online” manner, as well. Online training of machine learning model 124 comprises training the model with real-time data from HVAC system 106. In an example wherein a machine learning model is trained using a simulated HVAC, the machine learning model is free to make mistakes, which will be deemphasized by the model.

It is important that the machine learning model be trained according to certain comfort and safety constraints. Certain setpoint modifications may result in substantial increases in energy efficiency while being uncomfortable and/or unsafe for building occupants. For example, lowering the temperature dramatically in the winter may drastically reduce energy consumption of HVAC system 106, however, this can result in uncomfortable or unsafe workplace conditions for the building occupants. In an example, safety constraints may include a range of discharge air temperature setpoints, a range of static pressure setpoints, a rate of change of discharge air temperature setpoints, or a rate of change of static pressure set points. Comfort restraints may include parameters that ensure that the indoor conditions of the building do not become too hot or too cold. As an example, a comfort constraint could require a discharge air temperature setpoint to be greater than 56 degrees when the mixed air temperature is above 68 degrees. By following these constraints during training, the machine learning model will not suggest setpoint modifications that are unsafe or uncomfortable.

Energy efficiency application 120 additionally comprises a building management system (BMS) control module 126. The BMS control module 126 is configured to issue setpoint modification commands to BMS 104 of building 102. The setpoint modification commands issued by BMS control module 126 cause the BMS 104 to apply modification to setpoints of HVAC system 106. In certain embodiments, the BMS control module 126 is configured to cause the BMS 104 to control individual components of HVAC system 106, for example, to achieve a target setpoint modification. For example, the BMS control module 126 may cause the BMS control module 104 to open or close one or more dampers in HVAC system 106. As another example, the energy efficiency application 120 may cause the BMS control module 104 to restrict the number of times the compressor of HVAC system 106 is turned on, instead relying on other means within the system to achieve a target setpoint. The BMS control module 126 communicates with BMS 104 over network 130 using a Building Automation and Control Network (BACnet) or similar protocol.

Still referring to FIG. 1, exemplary operation of the energy efficiency application 120 is now described. When the energy efficiency application 120 is executed, the energy efficiency application 120 begins receiving data from BMS 104. The energy efficiency application 120 may receive updated data at equal intervals, for example, every 15 minutes. The data received from the BMS 104 comprises at least a first energy consumption metric for HVAC system 106. The first energy consumption metric is indicative of the energy consumed by HVAC system 106 over a period of time. The data received from the BMS 104 further comprises sensor data generated by building sensors. In an example, the sensor data is indicative of at least one of a mixed air temperature, an outside air temperature, or an air tonnage. As explained previously, the mixed air temperature is the temperature of the mixture of recirculated air and fresh input air from outside. The outside air temperature is the temperature of the outside air that is brough into the system form outside. The air tonnage is the amount of heat the system can remove from the building in one hour. These sensor data values inform the energy efficiency application 120 of the current state of the HVAC system 106. The sensor data may further comprise many other environmental conditions, such as humidity, pressure, building occupancy, etc. In some embodiments, energy efficiency application 120 may receive electrical grid data from electrical grid resource 136. The electrical grid data may be indicative of grid load in the area of building 102 or the current utility pricing. The electrical grid data can be used in addition to sensor data to generate optimized setpoint controls. For example, understanding that the grid load is higher at peak times, and therefore more expensive, the energy efficiency application 120 can optimize the setpoint modifications in view of a current price per kWh.

The sensor data values are received by the efficiency application 120 in real-time or near real-time (e.g., every 15 minutes). Receiving continuous data allows the efficiency application 120 to increase the effectiveness of the setpoint modification by adapting to environmental conditions as they happen. In an example, an office building is mostly empty because a substantial number of occupants have left early for a company party. In a conventional system, the HVAC system would continue to heat and cool the building as if everyone were present. In contrast, the efficiency application 120 can utilize real-time occupancy sensor data to determine that the building is less occupied than expected, and may adjust HVAC system setpoints accordingly.

The efficiency application 120 is further configured to alert the BMS 104 if sensor data is indicative of a problem with HVAC system 106. In an example, the efficiency application 120 receives sensor data that is beyond a threshold of acceptable possibilities. For instance, if an outside air temperature is 70 degrees but the mixed air temperature is 30 degrees, there is clearly a malfunction or misreading in one of the sensors. Efficiency application 120 can generate a notification alert for the BMS 104 when such an anomaly is detected. In another example, the efficiency application 120 may generate a notification alert for the BMS 104 if subsequent sensor data received after a setpoint modification was sent to the BMS 104 is indicative of the setpoint modification not being applied successfully, the efficiency application 120 can notify the BMS 104 that there is a potential issue within the HVAC system 106. Real-time monitoring of the HVAC system 106 provides the additional benefit of predictive maintenance through early recognition of malfunctions within the HVAC system 106.

Subsequent to receiving the sensor data, the energy efficiency application 120 provides the sensor data as input into machine learning model 124. Prior to receiving the sensor data inputs, machine learning model 124 is trained by way of reinforcement learning. In an example, the machine learning model 124 is trained used historical data from HVAC system 106.

In another example, machine learning model 124 is trained using a digital twin simulation of HVAC system 106. When training the machine learning model 124 using a simulated HVAC system, constraints may be applied to the training of the machine learning model 124 so as to exclude certain setpoint modifications that would result in unsafe or uncomfortable conditions in the building.

Once the machine learning model 124 is sufficiently trained, the energy efficiency application 120 provides the sensor data as input into the machine learning model 124. The machine learning model 124 may then output a setpoint modification that, when applied to the HVAC system 106, will result in an improved energy consumption metric. As an example, the setpoint modification may be a discharge air temperature setpoint. In another example, the setpoint modification is a static pressure setpoint. The energy efficiency optimization application 120 then transmits the setpoint modification to the BMS 104 and causes the setpoint modification to be applied to the HVAC system by the BMS 104.

In certain embodiments, building 102 is a grid interactive efficient building. Grid interactive efficient buildings are characterized by active use of distributed energy resources to optimized energy use for grid services, occupant needs and preferences, and cost reduction in a continuous and integrated way. In an example, energy efficiency application 120 utilizes grid resource information received form electrical grid resource 136 to determine setpoint modification based on a grid load. For example, in addition to sensor data, the energy efficiency application 120 can provide a grid load metric as input into the machine learning model 124. The energy efficiency application 120 may then take into account overall grid load when applying the setpoint modification. In some embodiments, the machine learning model 124 is trained using a grid interactive efficient building digital twin. The grid interactive efficient building digital twin can be used to predict grid load events, and provide energy demand forecasting.

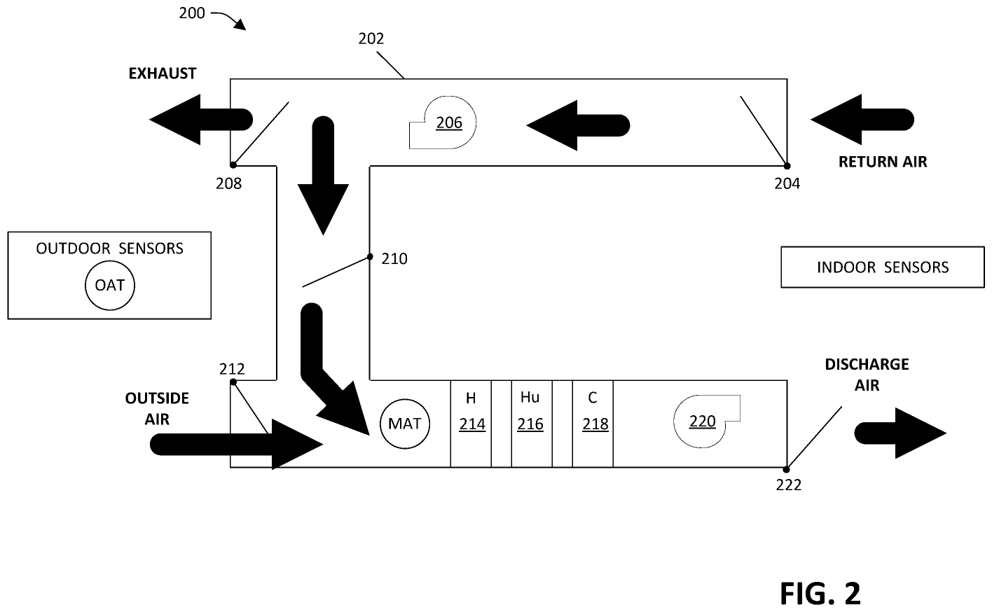

With reference to FIG. 2, an exemplary air handling unit (AHU) 200 associated with HVAC system 106 is illustrated. The AHU 200 demonstrates how air is moved throughout the HVAC system 106. The amount of air let into or out of the system is controlled using dampers. The dampers can be controlled by BMS 104 or they may be mechanized to open or close automatically, for example, according to pressure within the system. Damper 204 is a return damper that can control the amount of return air that is allowed back into the system for the purposes of either reconditioning or exhausting from the system. Blower 206 forces return air outward toward exterior exhaust and downward to be reconditioned by the AHU. Damper 208 is used to control the amount of air that is exhausted to the exterior of the building as opposed to recirculated in the AHU.

Damper 210 can control the amount of air that is allowed to recirculate. Damper 212 controls the amount of outside air that is introduced into the system. Outside air temperature (OAT) is measured by outside sensors 110. As outside air is introduced into the system, it is combined with the recirculated air. The resulting combination of air is measured by HVAC sensors as mixed air temperature (MAT). The OAT and MAT measurements are provided by the building management system to the energy efficiency application 120. Static pressure may be determined by sensors within ducts 202. The static pressure is the resistance to airflow within the air ducts of the HVAC system. For HVAC systems to function correctly, air needs to be pushed through the air ducts with greater intensity than the static pressure level within the ducts. An HVAC unit with either too high or too low static pressure will result in increased energy consumption and contribute to overall system inefficiency.

The mixed air is passed through a heating element 214, humidifier 216, and/or cooling element 218 before being expelled by blower 220 into the building as discharge air. The damper 222 can control how much discharge air is expelled. The heating element 214, humidifier 216, and cooling element 218 are configured to condition the mixed air before it is discharged. In some embodiments, the energy efficiency application 120 may cause the BMS 104 to modify the operation of one or more components of the AHU 200. For example, the energy efficiency application 120 may cause the BMS 104 to control one or more dampers to modify airflow in the system. In another example, the energy efficiency application 120 may cause the BMS 104 to prioritize input of outside air into the system rather than recirculation of conditioned air returning to the system from the return registers. In certain embodiments, the granularity of control offered by the BMS 104 along with the real-time performance feedback from the sensors 108, 110, and 112, of the various components of the HVAC system allows the energy efficiency application to achieve efficiencies through direct manipulation of components in the HVAC system.

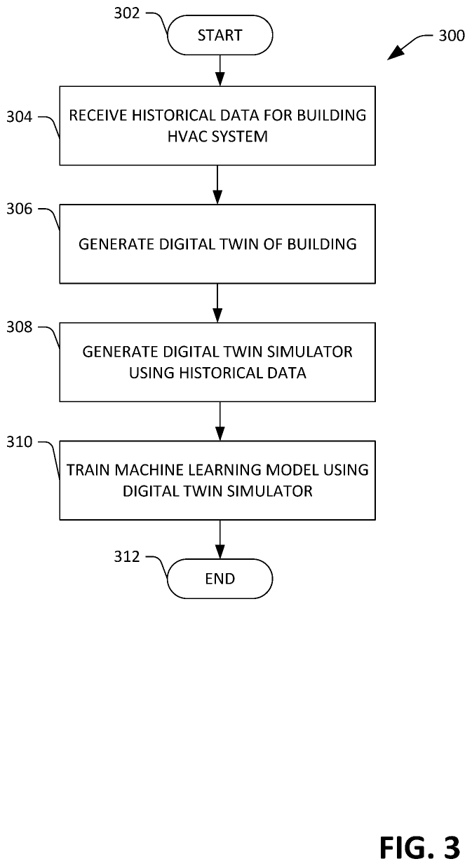

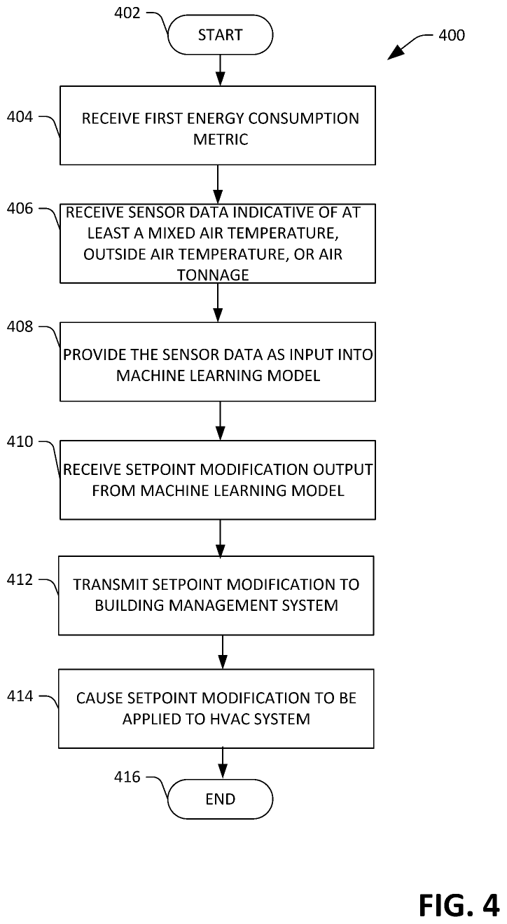

FIG. 3 is a flow diagram that illustrates an example methodology for training a machine learning model configured to determine a setpoint modification for an HVAC system. FIG. 4 is a flow diagram that illustrates an example methodology for generating and applying optimized setpoint modifications to an HVAC system.

While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring now solely to FIG. 3, a flow diagram that illustrates an example methodology 300 for training a machine learning model configured to determine a setpoint modification for an HVAC system is depicted. The methodology 300 begins at 302 and at 304, historical data for a building HVAC system is received. The historical data relates to the operational characteristics of the HVAC system, such as, for example, setpoints that were applied to the HVAC system and corresponding energy usage metrics for the setpoints during a period of time.

At 306, a digital twin is generated of the building where the HVAC system is located. A digital twin is a digital replication of aspects of a building, including associated technologies, systems, equipment, sensors, and actors.

At 308, a digital twin simulator is generated. The digital twin simulator is generated used the historical data from the HVAC system. The digital twin simulator has identical specifications of the HVAC system. The digital twin simulator is configured to simulate the real-world operation of the HVAC system in a digital environment.

At 310, the machine learning model is trained using the digital twin simulator. Training the machine learning model using the digital twin simulator enables the machine learning model to learn in an “online” manner that enables each decision to be made sequentially, in which positive outcomes are encouraged and negative outcomes discouraged. The methodology ends at 312 when the machine learning model is sufficiently trained and may be used to generate a modified HVAC setpoint that results in a reduction in energy consumption.

Referring now to FIG. 4, a flow diagram is presented that illustrates an example methodology 400 for generating and applying optimized setpoint modifications to an HVAC system. The methodology begins at 402, and at 404 a first energy consumption metric is received. The first energy consumption metric is indicative of the energy consumption of an HVAC system configured to regulate the indoor environment of a building.

At 406, sensor data indicative of at least one a mixed air temperature, an outside air temperature, or an air tonnage is received. The sensor data is received in real-time or near real-time.

At 408, the sensor data is provided as input into a machine learning model. The machine learning model has learned parameters assigned thereto, wherein the learned parameters are based on historical data for the HVAC system. The historical data may be actual or simulated historical data.

At 410, a setpoint modification output is received from the machine learning model. The setpoint modification output is a setpoint that, when applied to the HVAC system will result in a reduction in the energy consumption of the HVAC system.

At 412, the setpoint modification output is transmitted to a building management system configured to control the HVAC system.

At 414, the setpoint modification is caused to be applied to the HVAC system which results in a reduction in the energy consumption of the HVAC system. The methodology 400 ends at 416.

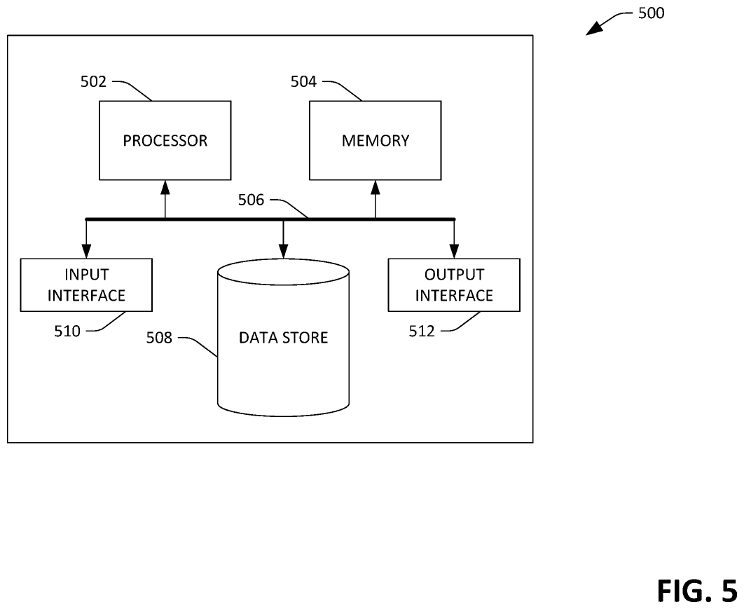

Referring now to FIG. 5, a high-level illustration of an exemplary computing device 500 that can be used in accordance with the systems and methodologies disclosed herein is illustrated. For instance, the computing device 500 may be used in a system that is configured to generate and apply optimized HVAC control setpoints. The computing device 500 includes at least one processor 502 that executes instructions that are stored in a memory 504. The instructions may be, for instance, instructions for implementing functionality described as being carried out by one or more components discussed above or instructions for implementing one or more of the methods described above. The processor 502 may access the memory 504 by way of a system bus 506. In addition to storing executable instructions, the memory 504 may also store content from a webpage, candidate assets, etc.

The computing device 500 additionally includes a data store 508 that is accessible by the processor 502 by way of the system bus 506. The data store 508 may include executable instructions, historical data, etc. The computing device 500 also includes an input interface 510 that allows external devices to communicate with the computing device 500. For instance, the input interface 510 may be used to receive instructions from an external computer device, from a user, etc. The computing device 500 also includes an output interface 512 that interfaces the computing device 500 with one or more external devices. For example, the computing device 500 may display text, images, etc. by way of the output interface 512.

It is contemplated that the external devices that communicate with the computing device 500 via the input interface 510 and the output interface 512 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 500 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 500 may be a distributed system. Thus, for instance, several devices may be in communication by way of a network connection and may collectively perform tasks described as being performed by the computing device 500.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Also described herein are features that accord to at least the following examples.

(A1) In an aspect, a method for modifying energy consumption by a building is described. The method includes receiving a first energy consumption metric for a heating, ventilation, and air conditioning (HVAC) system configured to regulate an indoor environment of a building, wherein the first energy consumption metric is indicative of the energy consumed by the HVAC system during operation. The method also includes receiving sensor data generated by a sensor, wherein the sensor data is indicative of a mixed air temperature. The method additionally includes receiving electrical grid data from an electrical grid resource. The method further includes providing the sensor data and the electrical grid data as input into a computer-implemented machine learning model that has learned parameters assigned thereto, wherein the learned parameters are based on historical data for the HVAC system, wherein the machine learning model is configured to determine a setpoint modification for the HVAC system based upon the sensor data and the electrical grid data, wherein the setpoint modification, when applied to the HVAC system, results in a second energy consumption metric for the HVAC system, wherein the second energy consumption metric is less than the first energy consumption metric. The method also includes transmitting the setpoint modification to a building management system associated with the HVAC system. The method additionally includes causing the setpoint modification to be applied to the HVAC system by the building management system.

(A2) In some embodiments of the method of (A1), the setpoint modification comprises an adjustment to a discharge air temperature setpoint or a static pressure setpoint.

(A3) In some embodiments of the method of at least one of (A1)-(A2), the setpoint modification comprises an adjustment to a discharge air temperature setpoint and a static pressure setpoint.

(A4) In some embodiments of the method of at least one of (A1)-(A3), causing the setpoint modification to be applied to the HVAC system by the building management system comprises transmitting instructions to the building management system that, when executed by the building management system, cause the building management system to control one or more dampers associated with the HVAC system.

(A5) In some embodiments of the method of at least one of (A1)-(A4), the method also includes receiving electrical pricing data from the electrical grid resource, wherein the electrical pricing data comprises a price per kilowatt hour (kWh) for electricity consumption. The method further includes providing the electrical pricing data as input into the computer-implemented machine learning model, wherein the machine learning model is configured to determine a second setpoint modification for the HVAC system based upon the electrical pricing data, wherein the second setpoint modification, when applied to the HVAC system, results in a third energy consumption metric, wherein the third energy consumption metric is less than the first energy consumption metric. The method additionally includes transmitting the third setpoint modification to the building management system associated with the HVAC system. The method also includes causing the third setpoint modification to be applied to the HVAC system by the building management system.

(A6) In some embodiments of the method of (A5), the electrical grid data comprises a grid load metric indicative of total grid load.

(A7) In some embodiments of the method of at least one of (A1)-(A6), the historical data is generated by a digital twin simulator, wherein the digital twin simulator is configured to simulate the behavior of the HVAC system in the building.

(A8) In some embodiments of the method of at least one of (A1)-(A7), the sensor data is received in real-time or near real-time.

(B1) In another aspect, a computing system includes a processor and memory, where the memory stores instructions that, when executed by the processor, cause the processor to perform at least one of the methods described herein (e.g., any of the methods of (A1)-(A8)).

(C1) In yet another aspect, a computer-readable storage medium is disclosed herein, where the computer-readable storage medium stores instructions that, when executed by a processor, cause the processor to perform at least one of the methods disclosed herein (e.g., any of the methods of (A1)-(A8)).

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computing system comprising:
a processor; and
memory storing an energy efficiency optimization application that, when executed by the processor, causes the energy efficiency optimization application to perform acts comprising:
receiving a first energy consumption metric for a heating, ventilation, and air conditioning (HVAC) system configured to regulate an indoor environment of a building, wherein the first energy consumption metric is indicative of the energy consumed by the HVAC system during operation;
receiving sensor data generated by a sensor, wherein the sensor data is indicative of an air tonnage of the HVAC system;
receiving electrical grid data from an electrical grid resource;
providing the sensor data and the electrical grid data as input into a computer-implemented machine learning model that has learned parameters assigned thereto, wherein the learned parameters are based on historical data for the HVAC system, wherein the machine learning model is configured to determine a setpoint modification for the HVAC system based upon the sensor data and the electrical grid data, wherein the setpoint modification, when applied to the HVAC system, results in a second energy consumption metric for the HVAC system, wherein the second energy consumption metric is less than the first energy consumption metric;
transmitting the setpoint modification to a building management system associated with the HVAC system; and
causing the setpoint modification to be applied to the HVAC system by the building management system.

2. The system of claim 1, wherein the setpoint modification comprises an adjustment to a discharge air temperature setpoint or a static pressure setpoint.

3. The system of claim 1, wherein the setpoint modification comprises an adjustment to a discharge air temperature setpoint and a static pressure setpoint.

4. The system of claim 1, wherein causing the setpoint modification to be applied to the HVAC system by the building management system comprises transmitting instructions to the building management system that, when executed by the building management system, cause the building management system to control one or more dampers associated with the HVAC system.

5. The system of claim 1, the acts further comprising:
receiving electrical pricing data from the electrical grid resource, wherein the electrical pricing data comprises a price per kilowatt hour (kWh) for electricity consumption;
providing the electrical pricing data as input into the computer-implemented machine learning model, wherein the machine learning model is configured to determine a second setpoint modification for the HVAC system based upon the electrical pricing data, wherein the second setpoint modification, when applied to the HVAC system, results in a third energy consumption metric, wherein the third energy consumption metric is less than the first energy consumption metric;
transmitting the third setpoint modification to the building management system associated with the HVAC system; and
causing the third setpoint modification to be applied to the HVAC system by the building management system.

6. The system of claim 1, wherein the electrical grid data comprises a grid load metric indicative of total grid load.

7. The system of claim 1, wherein the historical data is generated by a digital twin simulator, wherein the digital twin simulator is configured to simulate the behavior of the HVAC system in the building.

8. The system of claim 1, wherein the sensor data is received in real-time or near real-time.

9. A method for modifying energy consumption by a building, the method comprising:
receiving a first energy consumption metric for a heating, ventilation, and air conditioning (HVAC) system configured to regulate an indoor environment of a building, wherein the first energy consumption metric is indicative of the energy consumed by the HVAC system during operation;
receiving sensor data generated by a sensor, wherein the sensor data is indicative of a mixed air temperature;
receiving electrical grid data from an electrical grid resource;
providing the sensor data and the electrical grid data as input into a computer-implemented machine learning model that has learned parameters assigned thereto, wherein the learned parameters are based on historical data for the HVAC system, wherein the machine learning model is configured to determine a setpoint modification for the HVAC system based upon the sensor data and the electrical grid data, wherein the setpoint modification, when applied to the HVAC system, results in a second energy consumption metric for the HVAC system, wherein the second energy consumption metric is less than the first energy consumption metric;
transmitting the setpoint modification to a building management system associated with the HVAC system; and
causing the setpoint modification to be applied to the HVAC system by the building management system.

10. The method of claim 9, wherein the setpoint modification comprises an adjustment to a discharge air temperature setpoint or a static pressure setpoint.

11. The method of claim 9, wherein the setpoint modification comprises an adjustment to a discharge air temperature setpoint and a static pressure setpoint.

12. The method of claim 9, wherein causing the setpoint modification to be applied to the HVAC system by the building management system comprises transmitting instructions to the building management system that, when executed by the building management system, cause the building management system to control one or more dampers associated with the HVAC system.

13. The method of claim 9, further comprising:
receiving electrical pricing data from the electrical grid resource, wherein the electrical pricing data comprises a price per kilowatt hour (kWh) for electricity consumption;
providing the electrical pricing data as input into the computer-implemented machine learning model, wherein the machine learning model is configured to determine a second setpoint modification for the HVAC system based upon the electrical pricing data, wherein the second setpoint modification, when applied to the HVAC system, results in a third energy consumption metric, wherein the third energy consumption metric is less than the first energy consumption metric;
transmitting the third setpoint modification to the building management system associated with the HVAC system; and
causing the third setpoint modification to be applied to the HVAC system by the building management system.

14. The method of claim 13, wherein the electrical grid data comprises a grid load metric indicative of total grid load.

15. The method of claim 9, wherein the historical data is generated by a digital twin simulator, wherein the digital twin simulator is configured to simulate the behavior of the HVAC system in the building.

16. The method of claim 9, wherein the sensor data is received in real-time or near real-time.

17. A computer-readable storage medium comprising an energy efficiency application that, when executed by a processor, cause the energy efficiency application to perform acts comprising:
receiving a first energy consumption metric for a heating, ventilation, and air conditioning (HVAC) system configured to regulate an indoor environment of a building, wherein the first energy consumption metric is indicative of the energy consumed by the HVAC system during operation;
receiving sensor data generated by a sensor, wherein the sensor data is indicative of an outside air temperature;
receiving electrical grid data from an electrical grid resource;
providing the sensor data and the electrical grid data as input into a computer-implemented machine learning model that has learned parameters assigned thereto, wherein the learned parameters are based on historical data for the HVAC system, wherein the machine learning model is configured to determine a setpoint modification for the HVAC system based upon the sensor data and the electrical grid data, wherein the setpoint modification, when applied to the HVAC system, results in a second energy consumption metric for the HVAC system, wherein the second energy consumption metric is less than the first energy consumption metric;
transmitting the setpoint modification to a building management system associated with the HVAC system; and
causing the setpoint modification to be applied to the HVAC system by the building management system.

18. The computer-readable storage medium of claim 17, further comprising:
receiving electrical pricing data from the electrical grid resource, wherein the electrical pricing data comprises a price per kilowatt hour (kWh) for electricity consumption;
providing the electrical pricing data as input into the computer-implemented machine learning model, wherein the machine learning model is configured to determine a second setpoint modification for the HVAC system based upon the electrical pricing data, wherein the second setpoint modification, when applied to the HVAC system, results in a third energy consumption metric, wherein the third energy consumption metric is less than the first energy consumption metric;
transmitting the third setpoint modification to the building management system associated with the HVAC system; and
causing the third setpoint modification to be applied to the HVAC system by the building management system.

19. The computer-readable storage medium of claim 17, wherein causing the setpoint modification to be applied to the HVAC system by the building management system comprises transmitting instructions to the building management system that, when executed by the building management system, cause the building management system to control one or more dampers associated with the HVAC system.

20. The computer-readable storage medium of claim 17, wherein the setpoint modification comprises an adjustment to a discharge air temperature setpoint and a static pressure setpoint.
